(19) United States
(12) Patent Application Publication
(10) Pub. No.: US 2026/0346550 A1
(43) Pub. Date: Nov. 5, 2026

(54) STRAPPING MACHINE CONFIGURED TO FORM A WELDED STRAP JOINT

(71) Applicant: Signode Industrial Group LLC, Tampa, FL (US)

(72) Inventors: Jürgen Höhn, Bad Berneck (DE); Dimitrios Takidis, Dübendorf (CH); Hansjörg Hurni, Zürich (CH); Philipp Richter, Eckersdorf (DE); Christian Benz, Zürich (CH); Philipp Buser, Erlinsbach (CH); Michael Meng, Gipf-Oberfrick (CH)

(21) Appl. No.: 19/124,515

(22) PCT Filed: Oct. 26, 2023
(86) PCT No.: PCT/US2023/077884

§ 371 Date: Apr. 25, 2025

Related U.S. Application Data
(60) Provisional application No. 63/382,927, filed on Nov. 9, 2022.

(51) Int. Cl. B29C 65/20; B29C 65/10; B29C 65/14; B29C 65/16; B29C 65/32; B65B 13/32

(52) U.S. Cl. CPC B29C 65/20; B29C 65/103; B29C 65/1412; B29C 65/1432; B29C 65/1632; B29C 65/32; B65B 13/32

(57) ABSTRACT

Various embodiments of the present disclosure provide a strapping machine including a strap-sealing assembly configured to weld two overlapping portions of strap together by melting parts of each overlapping portion of the strap without contacting those parts of the strap and then clamping the overlapping portions of the strap together to form a strap joint.

### PRIORITY

This application claims priority to and the benefit of U.S. Provisional Patent Application No. 63/382,927, filed Nov. 9, 2022, the entire contents of which is incorporated herein by reference.

### FIELD

The present disclosure relates to a strapping machine for bundling and unitizing loads of goods, and more particularly to a strapping machine configured to weld two overlapping portions of strap together by melting parts of each overlapping portion of the strap without contacting those parts of the strap and then clamping the overlapping portions of the strap together to form a strap joint.

### BACKGROUND

A strapping machine forms a loop of plastic strap (such as polyester or polypropylene strap), metal strap (such as steel strap), or paper strap around a load. A typical strapping machine includes a support surface that supports the load, a strap chute that circumscribes the support surface, a strapping head that forms the strap loop using strap drawn from a strap supply, a controller that controls the strapping head to strap the load, and a frame that supports these components. A typical strapping head includes a strap-feeding assembly for feeding strap from the strap supply into and around the strap chute and for retracting the strap so it exits the strap chute and moves radially inwardly into contact with the load, a strap-tensioning assembly for tensioning the strap around the load, and a strap-sealing assembly for attaching two portions of the strap together to form the strap loop and for cutting the strap from the strap supply. The strapping machine includes several guides that define strap channels that the strap passes through as it moves through the various components of the strapping machine. The strap channels and the strap chute together define a strap path that the strap moves through.

To strap the load, the strapping machine carries out a strapping process including a strap-feeding process, a strap-retraction process, a strap-tensioning process, and a strap-sealing process. The strapping machine first carries out the strap-feeding process during which the strap-feeding assembly feeds strap (with the leading strap end first) from the strap supply through the strap-tensioning assembly, through the strap-feeding assembly, through the strap-sealing assembly, and into and around the strap chute until the leading strap end returns to the strap-sealing assembly. The strapping machine then carries out the strap-retraction process during which the strap-sealing assembly holds the leading strap end while the strap-feeding assembly retracts the strap to pull the strap out of the strap chute and onto and around the load. The strapping machine then carries out the strap-tensioning process during which the strap-tensioning assembly tensions the strap to a designated strap tension. The strapping machine then carries out the strap-sealing process during which the strap-sealing assembly attaches two overlapping portions of the strap to one another to form a strap joint and cuts the strap from the strap supply, thereby forming a strap loop around the load and completing the strapping process.

Certain strapping machines configured for plastic or paper strap include a hot-knife strap-sealing assembly to weld the two overlapping portions of the strap to one another. The strap-sealing assembly includes a workpiece that includes a resistive heating device. In operation, the resistive heating device is activated to heat the workpiece, and the heated workpiece is inserted between the two overlapping portions of the strap. A clamp forces the overlapping portions of the strap into contact with the workpiece such that the workpiece melts at least part of each of the overlapping portions of the strap. The clamp is released, and the workpiece is removed from between the overlapping portions of the strap. The clamp then clamps the overlapping portions of the strap together against a counter-pressure plate such that the melted parts of the overlapping portions of the strap join to form a welded strap joint.

To ensure the strap is properly welded, the workpiece must be heated to at least the melting temperature of the strap and held in contact with the strap until the strap melts. To speed up the melting process (which in turn lowers cycle time), the workpiece is typically heated to a temperature significantly higher than the melting temperature of the strap. This excessive temperature results in adequate strap joints but requires more energy use (increasing operating costs) and can generate generates undesirable smoke and ash byproducts as the workpiece contacts the strap and melts it.

### SUMMARY

Various embodiments of the present disclosure provide a strapping machine including a strap-sealing assembly configured to weld two overlapping portions of strap together by melting parts of each overlapping portion of the strap without contacting those parts of the strap and then clamping the overlapping portions of the strap together to form a strap joint.

### BRIEF DESCRIPTION OF THE FIGURES

FIG. 1 is a diagrammatic side view of one example embodiment of a strapping machine of the present disclosure.

FIG. 2 is a block diagram showing certain components of the strapping machine of FIG. 1.

FIG. 3 is a flowchart showing a strap-sealing process carried out by the strap-sealing assembly of the strapping machine of FIG. 1.

FIGS. 4A-4E are diagrammatic views of part of the strap-sealing assembly of the strapping machine of FIG. 1 during the strap-sealing process of FIG. 3.

FIG. 5A is a diagrammatic side view of part of the strap-sealing assembly of the strapping machine of FIG. 1 in which the strap-sealing assembly includes a heating device in the form of a resistive heating device.

FIG. 5B is a diagrammatic side view of part of the strap-sealing assembly of the strapping machine of FIG. 1 in which the strap-sealing assembly includes a heating device in the form of a hot-gas blower.

FIG. 5C is a diagrammatic side view of part of the strap-sealing assembly of the strapping machine of FIG. 1 in which the strap-sealing assembly includes a heating device in the form of a laser emitter.

FIG. 5D is a diagrammatic side view of part of the strap-sealing assembly of the strapping machine of FIG. 1 in which the strap-sealing assembly includes a heating device in the form of an induction coil.

FIG. 5E is a diagrammatic side view of part of the strap-sealing assembly of the strapping machine of FIG. 1 in which the strap-sealing assembly includes a heating device in the form of an infrared heating device.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

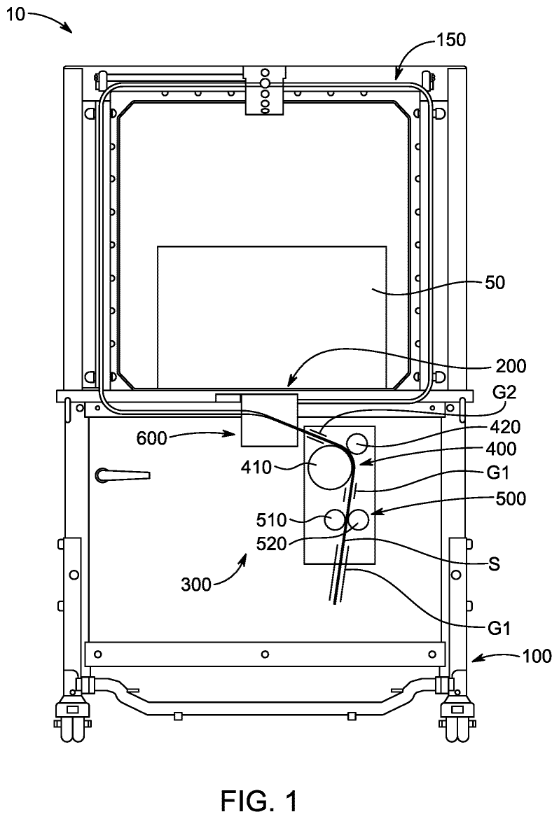

Various embodiments of the present disclosure provide a strapping machine including a strap-sealing assembly configured to weld two overlapping portions of strap together by melting parts of each overlapping portion of the strap without contacting those parts of the strap and then clamping the overlapping portions of the strap together to form a strap joint. FIGS. 1, 2, and 4A-4E show one example embodiment of a strapping machine 10 of the present disclosure and components thereof. The strapping machine 10 includes a frame 100, a strap chute 150, a load supporter 200, a strapping head 300, a controller 900, strap guides G1 and G2, and one or more sensors. The strapping machine 10 is configured to strap loads with strap drawn from a strap supply (not shown), such as a coil of strap mounted to the frame 100.

The frame 100 supports some (or all depending on the embodiment) of the other components of the strapping machine 10 and may be formed of any suitable components arranged in any suitable configuration. The load supporter 200 is supported by the frame 100 and is sized, shaped, positioned, oriented, and otherwise configured to support loads—such as the load 50 shown in FIG. 1—as they are strapped by and as they move through the strapping machine 10. The load supporter 200 includes a support surface (not labeled) on which loads are positioned during strapping and over which loads move as they move through the strapping machine 10. In this example embodiment, the support surface includes multiple rollers that facilitate movement of the loads across the load supporter 200. The rollers may be driven or undriven. In other embodiments, the support surface includes any other suitable driven conveyor.

The strap chute 150 is supported by the frame 100 and circumscribes the support surface of the load supporter 200. The strap chute 150 defines a strap path that the strap follows when fed through the strap chute 150 and from which the strap is removed when retracted. The strap chute 150 includes two spaced-apart first and second upstanding legs (not labeled); an upper connecting portion (not labeled) that spans the first and second legs; a first lower connecting portion (not labeled) within or beneath the load supporter 200 that connects the strapping head 300 with the first upstanding leg; and a second lower connecting portion (not labeled) within or beneath the load supporter 200 that connects the strapping head 300 with the second upstanding leg. The radially inward wall of the strap chute 150 is formed from one or more gates that are spring biased to a closed position that enables the strap to traverse the strap path when fed through the strap chute 150. When the strap-feeding assembly 400 exerts a pulling force on the strap to retract the strap, the pulling force overcomes the biasing force of the springs and causes the gate(s) to pivot to an open position, thereby releasing the strap from the strap chute 150 so the strap moves radially inward into contact with the load. A leading-end sensor 905 communicatively connected to the controller 900 is positioned and otherwise configured to detect the leading end of the strap when the leading end has traversed the strap chute 150 and returned to the strapping head 300, as explained below.

The strapping head 300 is configured to carry out the strapping process. The strapping head 300 is mounted to the frame 100 and includes a strap-feeding assembly 400, a strap-tensioning assembly 500, and a strap-sealing assembly 600.

The strap-feeding assembly 400 is configured to feed strap from the strap supply into and around the strap chute 150 and to, after the leading-end sensor 905 senses the leading end of the strap and the strap-sealing assembly 600 holds the leading end, retract the strap so it exits the strap chute 150 and contacts the load 50. The strap-feeding assembly 400 includes a drive roller 410, a pinch roller 420, and a strap-feeding actuator 490. The drive roller 410 is cylindrical (here, disc-shaped) and is rotatable about a drive-roller rotational axis. The pinch roller 420 is cylindrical (here, disc-shaped) and is freely rotatable about a pinch-roller rotational axis. The drive roller 410 and the pinch roller 420 are sized, shaped, positioned, and oriented such that their respective rotational axes are generally parallel and coplanar. The pinch roller 420 is positioned adjacent the drive roller 410 such that a nip is formed between the two rollers. The nip is sized such that the strap can be received in the nip and such that the drive roller 410 and the pinch roller 420 apply sufficient force to the strap to enable the drive roller 410 to feed and retract the strap around the load. In certain embodiments, at least part of the external cylindrical surface of the drive roller 410 and/or the pinch roller 420 is knurled or coated with a friction-enhancing material to facilitate engaging and dispensing the strap.

The strap-feeding actuator 490, which is an electric motor in this example embodiment but may include any suitable actuator, is operably connected to the drive roller 410 and configured to drive the drive roller 410 in opposing feed and retract rotational directions. The strap-feeding actuator 490 may be operably connected to the drive roller 410 in any suitable manner, such as via a keyed or splined connection and/or via a suitable drive train.

The strap-tensioning assembly 500 is configured to tension the strap around the load 50. The strap-tensioning assembly 500 includes a drive roller 510, a pinch roller 520, and a strap-tensioning actuator 590. The drive roller 510 is cylindrical (here, disc-shaped) and is rotatable about a drive-roller rotational axis. The pinch roller 520 is cylindrical (here, disc-shaped) and is freely rotatable about a pinch-roller rotational axis. The drive roller 510 and the pinch roller 520 are sized, shaped, positioned, and oriented such that their respective rotational axes are generally parallel and coplanar. The pinch roller 520 is also movable relative to the drive roller 510 between a tensioning position and a spaced position (not shown). When the pinch roller 520 is in the tensioning position, the pinch roller 520 is adjacent the drive roller 510 such that a nip is formed between the two rollers. The nip is sized such that the strap can be received in the nip and such that the drive roller 510 and the pinch roller 520 apply sufficient force to the strap to enable the drive roller 510 to tension the strap around the load. When the pinch roller 520 is in the spaced position, the pinch roller 520 is spaced-apart from the drive roller 510 such that the strap can pass freely between the two rollers. In this example embodiment, the pinch roller 520 is in the spaced position except during the strap-tensioning process, during which the pinch roller 520 is in the tensioning position. In certain embodiments, at least part of the external cylindrical surface of the drive roller 510 and/or the pinch roller 520 is knurled or coated with a friction-enhancing material to facilitate engaging and dispensing the strap.

The strap-tensioning actuator 590, which includes an electric motor in this example embodiment but may include any suitable actuator, is operably connected to the drive roller 510 and configured to drive the drive roller 510 in a tensioning rotational direction (which is the same rotational direction as the retract rotational direction in this example embodiment). The strap-tensioning actuator 590 may be operably connected to the drive roller 510 in any suitable manner, such as via a keyed or splined connection and/or via a suitable drive train.

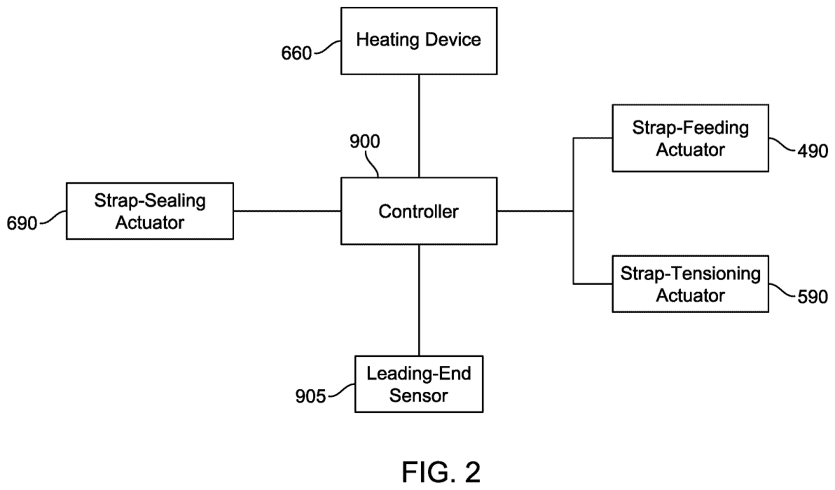

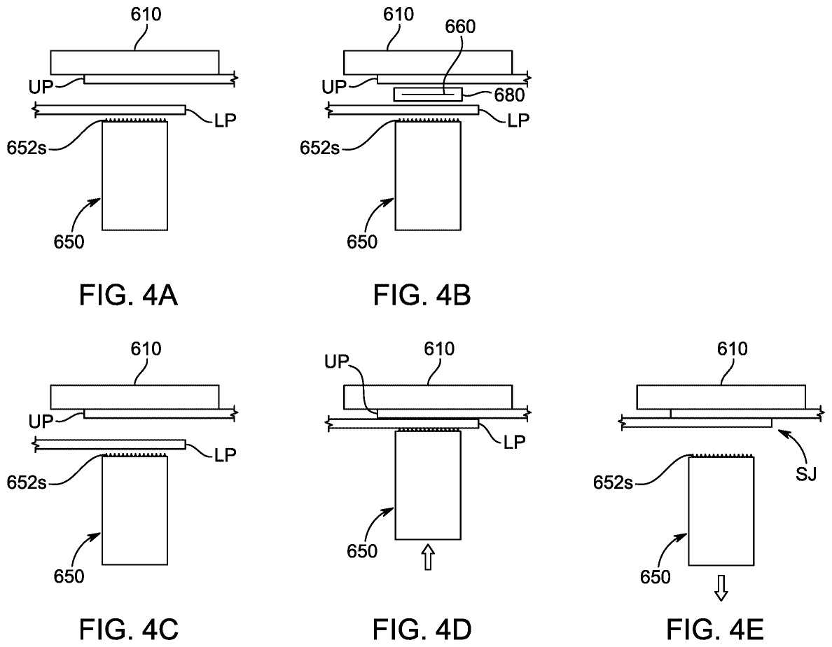

The strap-sealing assembly 600 is configured to, after the strap-tensioning assembly 500 tensions the strap to the designated tension, attach two overlapping portions of the strap to one another and cut the strap from the strap supply. As best shown in FIGS. 2 and 4A-4E, the strap-sealing assembly 600 includes a counter-pressure plate 610, a strap clamp 650, a heating device 660, a workpiece 680, and a strap-sealing actuator 690.

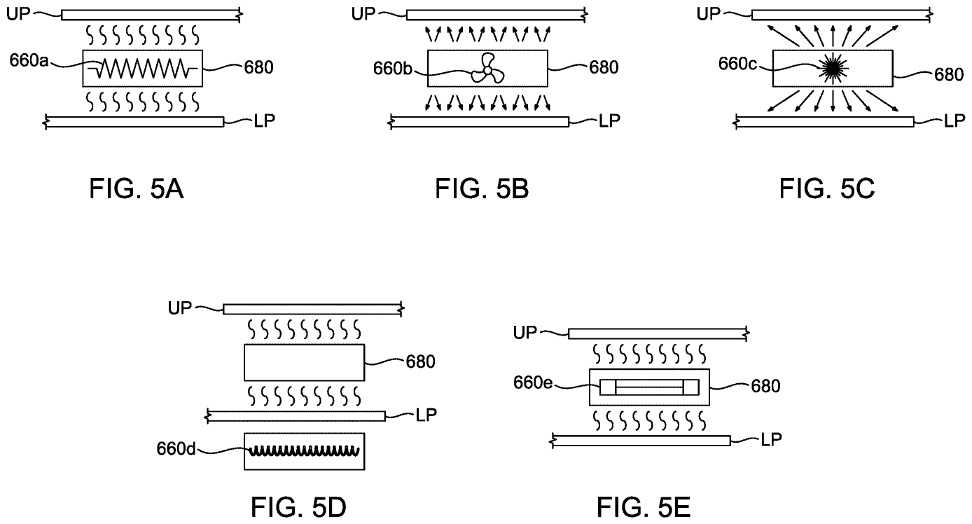

The counter-pressure plate 610 is movable between a home position (FIGS. 4A-4E) and a retracted position (not shown). The counter-pressure plate 610 is in the home position during the strapping process and is moved to the retracted position after the strap-sealing process is complete to release the tensioned strap loop so the load can be removed from the strapping machine 10. The strap clamp 650 includes a body 652 having a clamping surface 652s at one end. The strap clamp 650 is movable relative to the counter-pressure plate 610 between a home position (FIGS. 4A-4C and 4E) and a clamping position (FIG. 4D). The heating device 660 is any one of a plurality of different types of heating devices (such as those shown in FIGS. 5A-5E and described below) activatable to heat and melt parts of the strap without contacting those parts of the strap, as described below. The heating device 660 may be supported by the workpiece 680, fully or partially integrated into the workpiece 680, or supported by another component of the strap-sealing assembly 600 or the strapping device 10. The workpiece 680 is movable relative to the counter-pressure plate 610 and the strap clamp 650 between a home position (FIGS. 4A and 4C-4E) and a sealing position (FIG. 4B). This movement is into and out of the page with respect to the viewpoint shown in FIGS. 4A-4E and corresponds to movement transverse to the longitudinal direction of the strap.

The strap-sealing actuator 690, which is an electric motor in this example embodiment but may include any suitable actuator, is operably connected to and configured to move the above components of the strap-sealing assembly 600 to carry out the strap-sealing process.

Generally, the strap-feeding assembly 400, the strap-tensioning assembly 500, and the strap-sealing assembly 600 are together configured to form a tensioned strap loop around the load 50 by drawing strap from the strap supply and feeding it through the strap chute 150 in a feed direction, holding the leading strap end while retracting the strap in the retract direction to remove it from the strap chute 150 so it contacts the load 50, tensioning the strap around the load 50 to a designated tension, attaching two overlapping portions of the strap to one another to form a strap joint, and cutting the strap from the strap supply. In this example embodiment, the strapping machine 10 is a “tabletop” strapping machine in which the frame 100 supports the strap-feeding assembly 400, the strap-tensioning assembly 500, and the strap-sealing assembly 600. In other embodiments, one or more of these assemblies is not supported by the frame 100. For instance, in certain embodiments in which the strapping machine is configured to strap large loads, such as palletized loads, loads of lumber, or loads of corrugated, these assemblies are distinct, independently replaceable modules supported by different components of the strapping machine.

As best shown in FIG. 1, the first strap guide G1 extends from the strap supply (not shown) through the strap-tensioning assembly 500 and to the strap-feeding assembly 400 and is configured to guide the strap as it moves between those components. The second strap guide G2 extends between the strap-feeding assembly 400 and the strap-sealing assembly 600 and is configured to guide the strap as it moves between those components.

The controller 900 includes a processing device (or devices) communicatively connected to a memory device (or devices). For instance, the controller 900 may be a programmable logic controller. The processing device may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device may include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the strapping machine 10, such as to carry out the strap-sealing process 1000 described below.

The controller 900 is operably connected to the strap-feeding actuator 490, the strap-tensioning actuator 590, the heating device 660, and the strap-sealing actuator 690 and is configured to control these components. The controller 900 is communicatively connected to and configured to receive signals from and send signals to the leading-end sensor 905.

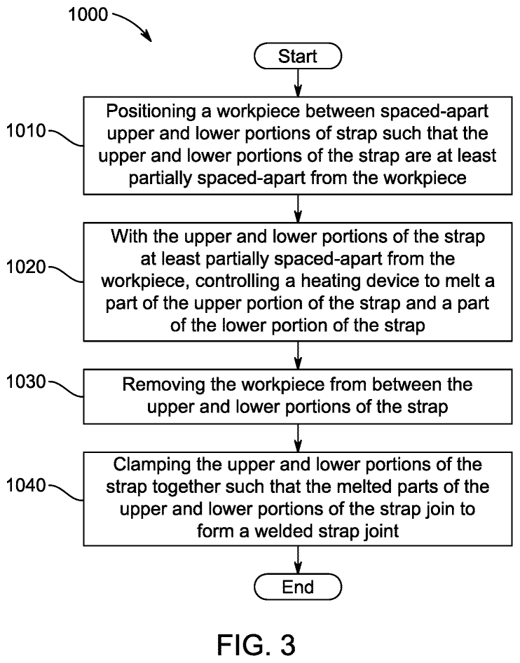

Operation of the strapping machine 10 to carry out a strapping process is now described. During the strapping process, the strapping machine 10 is configured to carry out: (1) a strap-feeding process by feeding strap from the strap supply around the strap chute 150 that surrounds the load 50; (2) a strap-retraction process by pulling the strap out of the strap chute 150 and onto and around the load 50; (3) a strap-tensioning process by tensioning the strap around the load 50 to a designated strap tension; and (4) a strap-sealing process 1000 (FIG. 3) by welding two overlapping portions of strap together by melting parts of each overlapping portion of the strap without contacting those parts of the strap and then clamping the overlapping portions of the strap together to form a strap joint.

After initiation of the strapping process, the controller 900 initiates the strap-feeding process and drives the strap-feeding actuator 490 to drive the drive roller 410 in the feed rotational direction to feed the strap S from the strap supply in the feed direction through the strap guide G1, between the drive roller 510 and the pinch roller 520 of the strap-tensioning assembly 500, through the strap guide G1, between the drive roller 410 and the pinch roller 420 of the strap-feeding assembly 400, through the strap guide G2, and through the strap-sealing assembly 600 and into and around the strap chute 150. The leading end of the strap S eventually returns to the strap-sealing assembly 600, at which point the leading-end sensor 905 senses the leading end and sends an appropriate signal to the controller 900. In response, the controller 900 stops driving the strap-feeding actuator 490 to stop the drive roller 410 and complete the strap-feeding process.

After the strap-feeding process is complete, the controller 900 initiates the strap-retraction process and drives the strap-sealing actuator 690 to cause the strap-sealing assembly 600 to clamp part of the strap S. The controller 900 then drives the strap-feeding actuator 490 to drive the drive roller 410 in the retract rotational direction to pull the first strap S1 in the retract direction and out of the strap chute 150 and onto and around the load, at which point the controller 900 stops driving the strap-feeding actuator 490 to stop the drive roller 410 and complete the strap-retraction process.

After the strap-retraction process is complete, the controller 900 initiates the strap-tensioning process and drives the strap-tensioning actuator 590 to drive the drive roller 510 in the tensioning rotational direction to pull the strap S in the retract direction and tension the strap S1 around the load. As this occurs, the controller 900 monitors the electrical current drawn by the strap-tensioning actuator 590. Once the current draw reaches a predetermined amount that is correlated with a predetermined strap tension, the controller 900 stops driving the strap-tensioning actuator 590 to stop the drive roller 510 and complete the strap-tensioning process.

After the strap-tensioning process is complete, the controller 900 initiates the strap-sealing process 1000 and drives the strap-sealing actuator 690 and controls the heating device 660 to weld two overlapping portions of strap together by melting parts of each overlapping portion of the strap without contacting those parts of the strap and then clamping the overlapping portions of the strap together to form a strap joint and to cut the strap S from the strap supply to complete the strap-sealing process.

The strap-sealing process 1000 is now described in detail with respect to the flowchart in FIG. 3. Before initiation of the strap-sealing process 1000, the strap has been tensioned around the load, and overlapping spaced-apart upper and lower portions of the strap are held in place. Upon initiation of the strap-sealing process 1000, a workpiece is positioned between the spaced-apart upper and lower portions of the strap such that the upper and lower portions of the strap are at least partially spaced-apart from the workpiece, as block 1010 indicates. With the upper and lower portions of the strap at least partially spaced-apart from the workpiece, a heating device is controlled to melt a part of the upper portion of the strap and a part of the lower portion of the strap, as block 1020 indicates. The workpiece is removed from between the upper and lower portions of the strap, as block 1030 indicates. The upper and lower portions of the strap are clamped together such that the melted parts of the upper and lower portions of the strap joint form a welded strap joint, as block 1040 indicates.

An example implementation of the strap-sealing process 1000 by the strapping machine 10 is now described with reference to FIGS. 4A-4E. As shown in FIG. 4A, before initiation of the strap-sealing process 1000, overlapping upper and lower portions UP and LP of the strap S are spaced-apart and held in place between the counter-pressure plate 610 and the strap clamp 650 and the counter-pressure plate 610, the strap clamp 650, and the workpiece 680 are at their respective home positions. Upon initiation of the strap-sealing process 1000, the controller 900 controls the strap-sealing actuator 690 to move the workpiece 680 to its sealing position, as shown in FIG. 4B. When the workpiece 680 is in its sealing position, the overlapping upper and lower portions UP and LP of the strap S are completely spaced-apart from—i.e., do not contact—the workpiece 680, though in other embodiments part of the upper and/or lower portion of the strap may contact the workpiece 680. The controller 900 also controls the heating device 660 to cause the heating device 660 to heat and melt the parts of the upper and lower portions UP and LP of the strap S facing the workpiece 680. The controller 900 controls the strap-sealing actuator 690 to move the workpiece 680 back to its home position, as shown in FIG. 4C. The controller 900 controls the strap-sealing actuator 690 to move the strap clamp 650 to the clamping position to clamp the upper and lower portions UP and LP of the strap S together and against the underside of the counter-pressure plate 610, as shown in FIG. 4D. This forces the melted parts of the upper and lower portions UP and LP of the strap S together such that, as the strap cools, they join to form a welded strap joint SJ. The controller 900 controls the strap-sealing actuator 690 to move the strap clamp 650 to its home position to release the strap joint SJ, as shown in FIG. 4E, and then to move the counter-pressure plate to its retracted position (not shown) to enable the load to be removed from the load supporter 200.

FIGS. 5A-5E show different types of heating devices 660a-660e, respectively, that may be included in the strap-sealing assembly 600, depending on the embodiment (though other types of heating devices may also be used).

The heating device 660a shown in FIG. 5A includes a resistive heating device that is part of the workpiece 680. The controller 900 is configured to activate the resistive heating device 660a to heat the workpiece 680. The heated workpiece 680 emits thermal radiation that heats and melts the strap. In another embodiment (not shown) the heating device includes a closed-loop heating element with an integrated meander that is part of the workpiece.

The heating device 660b shown in FIG. 5B includes a hot-gas blower. The controller 900 is configured to activate the hot-gas blower to generate hot gas (such as heated air) and direct the hot gas through openings defined through the workpiece 680 such that the hot gas impinges on the upper and lower portions of the strap and heats and melts the strap.

The heating device 660c shown in FIG. 5C includes a laser emitter supported by the workpiece 680. The controller 900 is configured to activate the laser emitter 660c to emit a laser onto the upper and lower portions of the strap to heat and melt the strap via laser radiation. The laser emitter may be configured to emit the laser in any suitable pattern, such as a spot pattern, a line pattern, or a surface pattern.

The heating device 660d shown in FIG. 5D includes an induction coil positioned near the workpiece 680, such as in the strap clamp 650 or the counter-pressure plate 610. The controller 900 is configured to activate an inverter (not shown) to output high-frequency alternating current to the induction coil 660e. This alternating current flows to and through the electrically conductive induction coil 660e, which generates a magnetic field around the induction coil 660e. When the electrically conductive workpiece 680 is positioned close enough to the induction coil 660e such that it is positioned within the magnetic field around the induction coil 660e, the magnetic field induces eddy currents in the workpiece 680, and the workpiece 680 heats up due to the internal resistance to the flow of the induced eddy currents. The heated workpiece 680 emits thermal radiation that heats and melts the strap.

The heating device 660e shown in FIG. 5E includes an infrared heating device that is part of the workpiece 680. The controller 900 is configured to activate the infrared heating device 660e, which emits infrared radiation that heats and melts the strap. In certain embodiments, the infrared heating device is configured to heat the workpiece 680 via infrared radiation, which in turn emits thermal radiation that heats and melts the strap.

In certain embodiments, a cover is attached to the workpiece. The cover is formed from a thermal insulator, that is, a material that does not conduct heat. The cover prevents the strap from directly contacting the workpiece and, therefore, prevents the workpiece from directly transmitting heat to the strap.

1. A strapping device comprising:
a movable workpiece;
a movable strap clamp;
a heating device; and
a controller configured to:
cause the workpiece to move between a first strap portion and a second strap portion such that the first strap portion and the second strap portion are at least partially spaced-apart from the workpiece;
with the first and second strap portions at least partially spaced-apart from the workpiece, control the heating device to heat and melt a part of the first strap portion and a part of the second strap portion;
cause the workpiece to be removed from between the first and second strap portions; and
cause the strap clamp to move to clamp the first and second strap portions together such that the melted parts of the first and second strap portions join to form a welded strap joint.

2. The strapping device of claim 1, wherein the heating device is configured to heat the parts of the first and second strap portions to a temperature no less than a melting temperature of the strap.

3. The strapping device of claim 1, wherein the heating device comprises a resistive heating device and the controller is configured to control the resistive heating device to heat the workpiece such that the workpiece emits thermal radiation that heats and melts the parts of the first and second strap portions.

4. The strapping device of claim 1, wherein the heating device comprises a hot-gas blower and the controller is configured to control the hot-gas blower to generate and direct hot gas onto the parts of the first and second strap portions to heat and melt the parts of the first and second strap portions.

5. The strapping device of claim 4, wherein multiple openings are defined in the workpiece, wherein the hot-gas blower is configured to direct the hot gas through the openings in the workpiece.

6. The strapping device of claim 1, wherein the heating device comprises a laser emitter and the controller is configured to control the laser emitter to emit a laser onto the parts of the first and second strap portions to heat and melt the parts of the first and second strap portions via laser radiation.

7. The strapping device of claim 1, wherein the heating device comprises an induction coil and the controller is configured to control an inverter to output alternating electric current to the coil at a designated frequency to cause the workpiece to be heated by induction such that the workpiece emits thermal radiation that heats and melts the parts of the first and second strap portions.

8. The strapping device of claim 1, wherein the heating device comprises an infrared heating device and the controller is configured to control the infrared heating device to heat the and melt the parts of the first and second strap portions via infrared radiation.

9. The strapping device of claim 1, further comprising an actuator, wherein the controller is configured to control the actuator to cause the workpiece to and the strap clamp to move.

10. The strapping device of claim 1, wherein the heating device is one of: integrated into the workpiece and separate from the workpiece.

11. A strap-sealing process comprising:
positioning a workpiece between a first strap portion and a second strap portion such that the first strap portion and the second strap portion are at least partially spaced-apart from the workpiece;
with the first and second strap portions at least partially spaced-apart from the workpiece, heating and melting a part of the first strap portion and a part of the second strap portion;
removing the workpiece from between the first and second strap portions; and
moving a strap clamp to clamp the first and second strap portions together such that the melted parts of the first and second strap portions join to form a welded strap joint.

12. The strap-sealing process of claim 11, further comprising heating the parts of the first and second strap portions to a temperature no less than a melting temperature of the strap.

13. The strap-sealing process of claim 11, wherein heating the parts of the first and second strap portions comprises controlling a resistive heating device to heat the workpiece such that the workpiece emits thermal radiation that heats and melts the parts of the first and second strap portions.

14. The strap-sealing process of claim 11, wherein heating the parts of the first and second strap portions comprises controlling a hot-gas blower to generate and direct hot gas onto the parts of the first and second strap portions to heat and melt the parts of the first and second strap portions.

15. The strap-sealing process of claim 11, wherein heating the parts of the first and second strap portions comprises controlling a laser emitter to emit a laser onto the parts of the first and second strap portions to heat and melt the parts of the first and second strap portions via laser radiation.

16. The strap-sealing process of claim 11, wherein heating the parts of the first and second strap portions comprises controlling a control an inverter to output alternating electric current to a coil at a designated frequency to cause the workpiece to be heated by induction such that the workpiece emits thermal radiation that heats and melts the parts of the first and second strap portions.

17. The strap-sealing process of claim 11, wherein heating the parts of the first and second strap portions comprises controlling an infrared heating device to heat the and melt the parts of the first and second strap portions via infrared radiation.

18. The strap-sealing process of claim 11, further comprising controlling an actuator to cause the workpiece to and the strap clamp to move.
